(19) United States
(12) Patent Application Publication
(10) Pub. No.: US 2010/0251583 A1
(43) Pub. Date: Oct. 7, 2010

(54) INCIDENT LIGHT MANAGEMENT DEVICES AND RELATED METHODS AND SYSTEMS

(75) Inventors: Brent W. Brown, Farmington, UT (US); Clifford B. Brown, Smithfield, UT (US)

Correspondence Address: TRASKBRITT, P.C., P.O. BOX 2550, SALT LAKE CITY, UT, 84110, US

(73) Assignee: YOUNG ELECTRIC SIGN COMPANY, Salt Lake City, UT (US)

(21) Appl. No.: 12/416,856

(22) Filed: Apr. 1, 2009

(51) Int. Cl. G09F 13/04; G09F 13/22

(52) U.S. Cl. 40/544; 40/564

(57) ABSTRACT

Incident light management devices, display devices, methods of managing incident light for displays, and other related methods and devices are disclosed. A display module comprises one or more pixel rows and a panel, the panel including a plurality of apertures formed therethrough and at least one incident light management region comprising corrugations. A method of managing incident light for a light emitting display comprises receiving incident light onto at least one first slanted surface, absorbing at least a portion of the incident light with the at least one first slanted surface, reflecting at least a portion of the incident light toward at least one second slanted surface, and absorbing at least a portion of the reflected incident light with the at least one second slanted surface.

### CROSS-REFERENCE TO RELATED APPLICATION

This application is related to U.S. patent application Ser. No. 11/448,594, filed on Jun. 6, 2006, pending, in the name of Brent W. Brown, assigned to the assignee of the present application. The disclosure of the foregoing application is hereby incorporated herein in its entirety by reference.

### BACKGROUND

1. Field of the Invention

The present invention relates generally to managing incident light for display boards, such as electronic displays and billboards.

2. State of the Art

Billboards and large signs have been used for many years to convey information to passersby such as advertising, traffic messages, and the like. Traditionally these signs and billboards were only capable of delivering a single message or advertisement. This message was generally printed on strips of paper that were then adhered to the billboard. To change the message, new paper needed to be printed and adhered to the billboard.

More recently, display boards and billboards have become electronic using lights, light emitting diodes (LEDs), and combinations of the two to display a visual message that could be easily adaptable to display a wide variety of messages in the form of words and images from the same sign without having to physically change the characteristics of the sign. These electronic boards can easily modify a graphic image or message to create video displays and modify the type of message or advertisement that is shown on the electronic board at regular intervals, or at targeted times depending on expected traffic near the sign, or public interest. These possible images are generally referred to herein as adaptable images.

As electronic displays may be located outdoors, in stadiums, or other brightly lit locations, the electronic displays may be exposed to substantial incident light, such as sunlight, or man-made light sources. Incident light may be reflected from surfaces of the electronic display and reduce the effective contrast ratio of the electronic display. Additionally, reflected incident light may cause images displayed by the electronic billboard to appear less vibrant and clear, and in some circumstances may cause the displayed images to be unperceivable to a viewer.

In view of the above, there is a need for improved devices and methods for incident light management for display modules.

### BRIEF SUMMARY

The present invention provides display modules, methods of making display modules, and methods of managing incident light for light emitting displays.

One embodiment of the present invention comprises a display module comprising a panel and at least one pixel row. The panel includes a plurality of apertures formed therethrough and at least one incident light management region comprising corrugations. The at least one pixel row comprises a plurality of pixel arrangements positioned and configured to display at least a portion of an adaptable image, wherein each pixel arrangement of the plurality is positioned at least partially within at least one aperture.

Another embodiment of the present invention comprises a method of making a display module, the method comprising forming a panel, forming a plurality of pixel apertures through the panel, and forming corrugations in at least one surface region of the panel to form at least one incident light management structure.

Yet another embodiment of the present invention comprises a method of managing incident light for a light emitting display. The method includes receiving incident light onto at least one first slanted surface, absorbing at least a portion of the incident light with the at least one first slanted surface, reflecting at least a portion of the incident light toward at least one second slanted surface, and absorbing at least a portion of the reflected incident light with the at least one second slanted surface.

### BRIEF DESCRIPTION OF THE DRAWINGS

FIG. 1 illustrates a plurality of removable panels arranged in a matrix organization.

FIG. 2 illustrates an exploded view of removable panels for attachment to frame members.

FIG. 3 shows a front view of a removable panel including incident light management regions according to an embodiment of the present invention.

FIG. 4 shows a side view of the removable panel shown in FIG. 3.

FIG. 5 shows a detail of a front view of the removable panel shown in FIG. 3.

FIG. 6 shows a cross-sectional view of a portion of the removable panel shown in

FIG. 5.

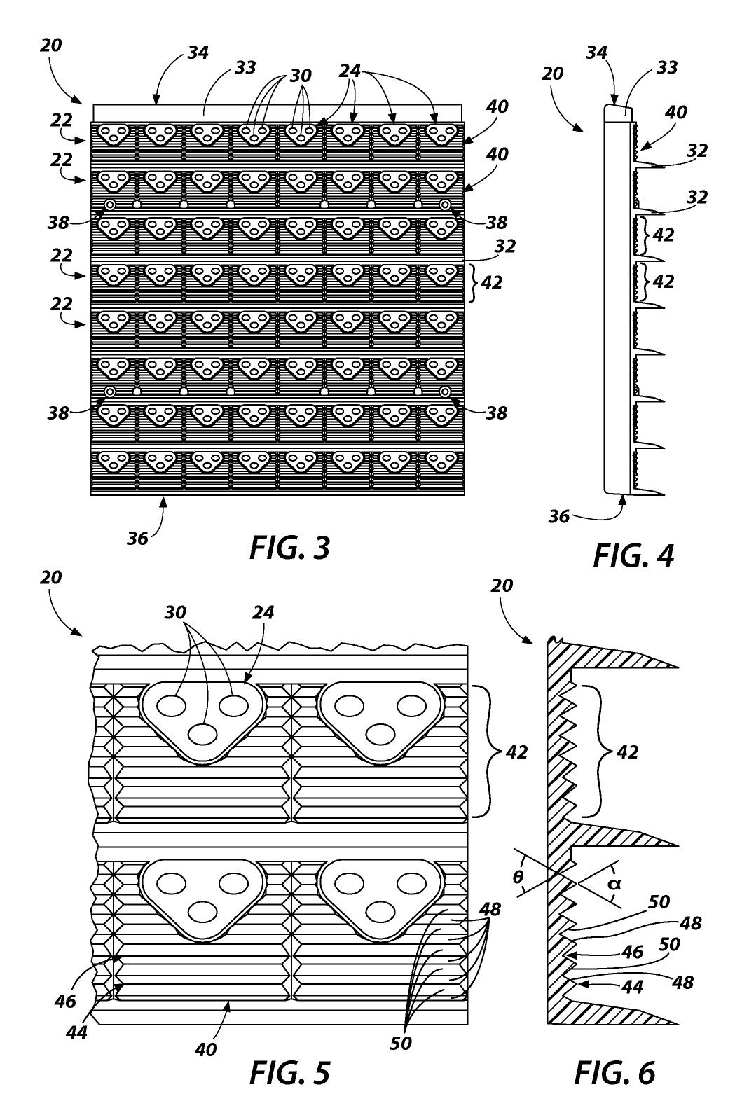

FIG. 7 shows an isometric detail view of a portion of the removable panel shown in FIG. 3 including multiple pixel arrangements.

FIG. 8 illustrates a side view of LEDs forming one pixel on a portion of a circuit board and a portion of a removable panel showing one pixel arrangement.

FIG. 9 shows the circuit board portion and the removable panel portion of FIG. 8 assembled together.

FIG. 10 shows the assembly of FIG. 9 with a sealant disposed in a recess of the removable panel portion.

FIG. 11 shows a cross-sectional view of a portion of a panel having a surface that is substantially parallel to a display surface and includes an illustration of rays of incident light and reflected light.

FIG. 12 shows a cross-sectional view of a portion of the panel shown in FIG. 3 having incident light management regions and includes an illustration of rays of incident light and reflected light.

### DETAILED DESCRIPTION

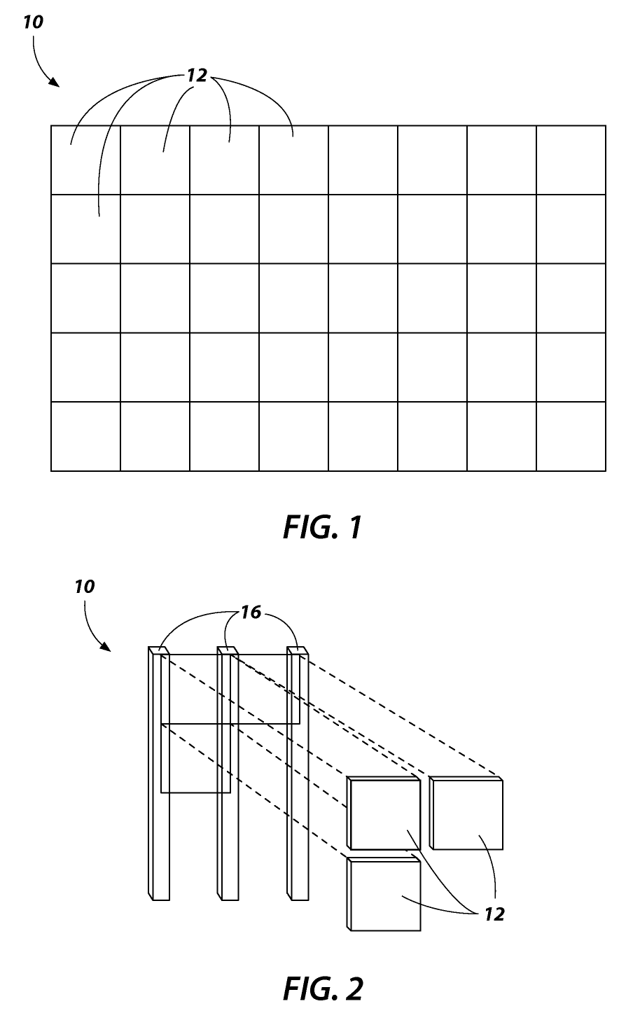

A display apparatus 10 may be comprised of a single display module 12, or, as illustrated in FIGS. 1 and 2, a display apparatus 10 may comprise a plurality of display modules 12 arranged in a matrix organization. Additionally, these display modules 12 may be arranged in a variety of configurations for different applications. For example, the matrix organization may include a single row of display modules 12 (or a single column of display modules 12) for creating a narrow yet long display, which may be suitable for displaying messages in a traveling ticker-tape type of arrangement. A small number of display modules 12 may be used to create a relatively small display apparatus 10, or a large number of display modules 12 may be arranged to create a relatively large display apparatus 10. By way of example and not limitation, a relatively large billboard size display apparatus 10 may include a matrix organization of 1100 or more display modules 12 in a rectangular configuration. Additionally, using a plurality of display modules 12 to form a larger display apparatus 10 may allow for the easier maintenance, installation, and removal of the display apparatus 10. For example, each display module 12 of the display apparatus 10 may be readily removed and replaced, such as by devices and methods described in U.S. Patent Publication No. 2007/0279314 Al, by an inventor of the present invention and assigned to the assignee of the present invention, incorporated in its entirety herein by this reference.

As illustrated in an exploded view in FIG. 2, a plurality of display modules 12 may be attached to frame members 16 as part of the display apparatus 10. The frame members 16 may extend vertically and each module 12 may be placed in a removable panel position such that it abuts a neighboring display module 12 horizontally. The display modules 12 also may be stacked vertically to form the overall display apparatus 10 for presenting the adaptable image. The overall display apparatus 10 may be configured to display an adaptable image, such as for example, a series of still images, or a video image. In many embodiments, which include many display modules 12, each display module 12 may be configured to form only a relatively small portion of the overall adaptable image.

While not illustrated, it will be understood by those of ordinary skill in the art that the display modules 12 may be operably wired together and coupled to a controller configured for operating each of the display modules 12, and each of the pixels on each display modules 12. For example, the controller may operate one or more LEDs within each pixel. Many wiring options may be possible, such as for example a serial connection between all of the panels such that the panels are essentially daisy-chained together. Furthermore, many controller configurations are possible for controlling the pixels and defining what adaptable images, in the form of still images or video, may be displayed on the display apparatus.

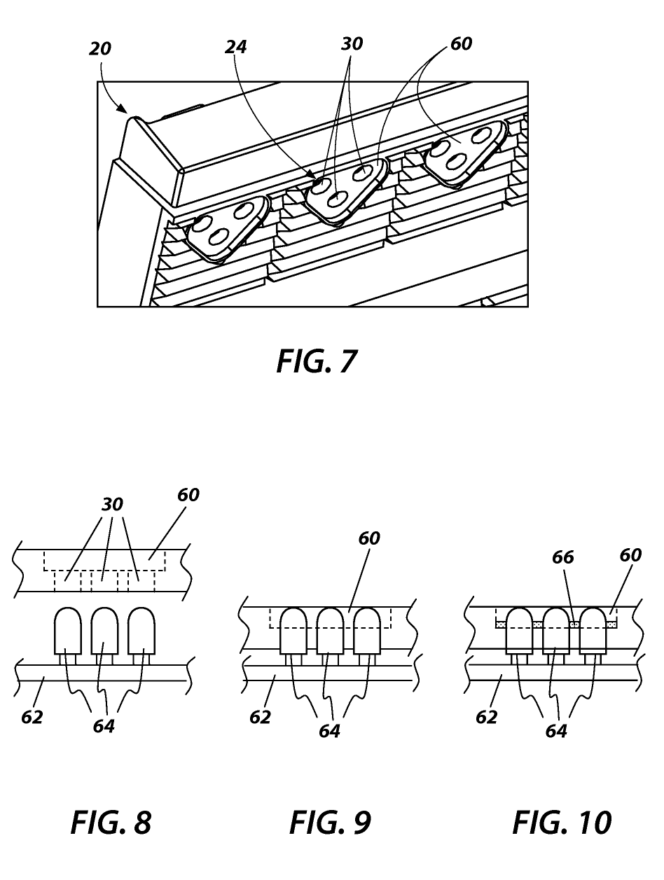

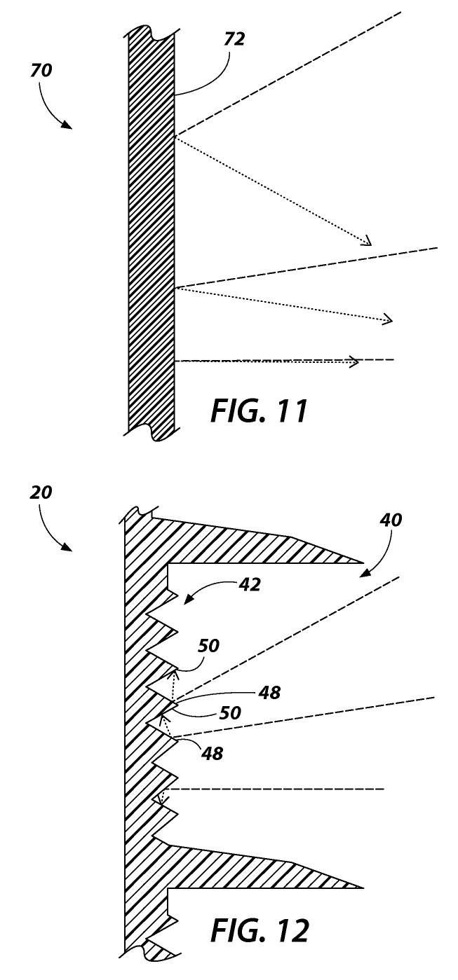

Each display module 12 includes a removable panel 20, as shown in FIGS. 3 and 4. FIG. 3 illustrates a front view of an embodiment of removable panel 20 for a display module 12, and FIG. 4 illustrates a side view of the removable panel 20 shown in FIG. 3. Additionally, a detail of a front view of a portion of the removable panel 20 is shown in FIG. 5, and a cross-sectional view of a portion of the removable panel 20 is shown in FIG. 6.

Each display module 12 includes one or more pixel rows 22 comprising a plurality of pixel arrangements 24 positioned and configured to display at least a portion of an adaptable image. The removable panel 20 may further comprise horizontal fins 32 and incident light management regions 40. Each pixel row 22 may include a plurality of pixel arrangements 24, and each pixel arrangement 24 may include one or more apertures 30. For example, each pixel arrangement 24 may include three apertures 30 for receiving Light Emitting Diodes (LEDs) (FIGS. 8-10), or other suitable light emitting devices. The removable panel 20 is illustrated with a plurality of pixel rows 22; however, the removable panel 20 may also be formed having only a single pixel row 22. Additionally, the removable panel 20 may be formed having any number of pixel arrangements 24 and may include different pixel row geometries as well as different overall geometries.

The removable panel 20 may further include a protrusion 33 extending from a top side 34 and a receiving rim (not shown) along a bottom side 36. For attachment, the removable panel 20 may include four coupler holes 38 formed through the removable panel 20, as shown in FIG. 3. These coupler holes 38 may be configured for receiving coupling devices (not shown) that may be used for coupling the removable panel 20 to frame members 16 of a full display apparatus 10 (FIGS. 1 and 2). Of course, additional embodiments of the removable panel 20 may include less than, or more than, the four coupler holes 38 shown in FIG. 3.

The incident light management regions 40 of each removable panel 20 may comprise surface corrugations 42, which may be formed by a plurality of alternating ridges 44 and valleys 46. For example, the surface corrugations 42 may be formed by a plurality of substantially similar alternating ridges 44 and valleys 46 that repeat at about 0.112 inch (2.8 mm) intervals. In some embodiments, the ridges 44 may be oriented substantially parallel to the orientation of each pixel row 22. However, other orientations of ridges 44 are possible. The ridges 44 and valleys 46 may be formed by converging and diverging slanted surfaces 48 and 50. As used herein, the term “slanted” means substantially non-parallel to a substantially planar display surface, or substantially non-parallel to a plane tangent the display surface at that particular location on a display surface that is non-planar, such as an arcuate display surface. As used herein, the term “display surface” means a theoretical surface defined by the pixels of the display; for example, a plane that substantially intersects each pixel of the display. Additionally, the surface corrugations 42 may be any number of sizes, including organized structures on a micro-scale, as well as relatively large structures.

The incident light management regions 40 may be distributed over the removable panel 20 and may be positioned adjacent each pixel arrangement 24 of the display 12. The incident light management regions 40 may reduce the amount of panel surface that is oriented parallel to the display surface and may reduce the amount of incident light reflected from the panel surface. For example, each of the plurality of converging and diverging slanted surfaces 48 and 50 may be oriented non-parallel to the display surface. Each converging and diverging slanted surface 48 and 50 of the plurality of converging and diverging slanted surfaces 48 and 50 may be contiguous with at least another converging and diverging slanted surface 48 and 50 of the plurality of converging and diverging slanted surfaces 48 and 50 to provide substantially continuous surface corrugations 42 forming each incident light management region 40. In some embodiments, each ridge 44 may come to a relatively sharp and well defined point or edge at its apex or peak, where the slanted surfaces 48 and 50 that form the ridge 44 meet. In view of this, the amount of light that may be reflected from the peak or edge of each ridge 44 at an angle different from either of the slanted surfaces 48 and 50 that form the ridge 44 may be relatively small. Additionally, the slanted surfaces 48 and 50 may meet to form a relatively well defined corner or junction at the bottom of each of the valleys 46.

Each of the ridges 44 may be at least partially defined by contiguous slanted surfaces 48 and 50 that define an angle α therebetween. Additionally, each of the valleys 46 may be at least partially defined by contiguous slanted surfaces 48 and 50 that define an angle θ therebetween. In some embodiments, the angle α, which may define each ridge 44, and the angle θ, which may define each valley 46, may both be acute angles. In other words, each of angles α and θ may be an angle that is less than 90 degrees. In some embodiments, the angles α and θ that define the ridges 44 and valleys 46 may vary within each incident light management region 40. For example, the angle α defining each ridge 44 may vary between about 60 degrees and about 69 degrees and the angle θ defining each valley 46 may vary similarly. In additional embodiments, the angle α defining each ridge 44 may be substantially the same and the angle θ defining each valley 46 may be substantially the same. In yet additional embodiments, the angles α and θ may include any number of angles that are non-parallel to the display surface. For example, the angles α and θ may be more acute than 60 degrees, or the angles may be somewhat obtuse.

In some embodiments, the surface corrugations 42 may be formed by a plurality of generally pyramidal shaped structures. As used herein, the term “pyramidal” includes, for example, shapes with four generally triangular sides, and shapes with two generally triangular sides and two generally trapezoidal sides such as shown in FIGS. 3, 5, and 7. For example, the surface corrugations 42 may be formed by a plurality of elongated generally pyramidal shaped structures with two generally triangular sides and two generally trapezoidal sides. Each elongated generally pyramidal shaped structure may include an elongated ridge, defined by the junction of the two trapezoidal sides, which may be oriented substantially parallel to each pixel row 22.

The removable panel 20 may further comprise a plurality of substantially horizontal shading fins 32 positioned for shading at least one of the pixel rows 22. Each horizontal shading fin 32 may be configured to shade the pixel arrangements 24 from direct sunlight when installed outdoors, or from overhead light when installed indoors. Consequently, the horizontal shading fins 32 enable a higher contrast ratio, which may assist in viewing the display module 12 of display apparatus 10 (FIGS. 1 and 2) and making an adaptable image appear as if it includes greater intensity and more vibrant colors. In the embodiments illustrated herein, the removable panel 20 may be formed of plastic with the fins 32 which are also formed of plastic and as an integral part of the removable panel 20. However, the fins 32 may also be formed separately and, for example, may be overlayed onto the front of the removable panel 20.

Additionally, the surface of the removable panel 20, including each fin 32, may comprise a dark colored material, which may further enhance the contrast ratio. For example, the surface of the removable panel 20 may be a color that is near to black and may absorb a majority of the light wavelengths within the visible spectrum. In some embodiments, the removable panel 20 may be formed from a dark material, such as a dark plastic, fiberglass, or other material. In additional embodiments, the removable panel 20 may be coated with a dark material, such as a dark paint.

FIG. 7 shows a detail of a portion of the removable panel 20 which includes pixel arrangements 24. In this embodiment, each pixel arrangement 24 includes three apertures 30 and is encompassed by a recessed area 60. Of course, additional embodiments may include other pixel arrangements 24 and geometries. For example, a pixel arrangement 24 may include a single aperture 30 for a single light element or two apertures 30 for two light elements such as, for example, LEDs. In some embodiments, a pixel arrangement of one or two LEDs may be used for a monochrome display. In additional embodiments, pixel arrangements may include multi-color LEDs for each pixel, such that a multi-color display may be achieved even from a single LED for each pixel. In the embodiment illustrated herein, three apertures 30 are used for each pixel arrangement 24 such that the light from a red LED, a green LED, and a blue LED may be combined to generate various colors for a full color spectrum video display capable of showing still images and video images using conventional computer color maps. In additional embodiments, the pixel arrangements 24 may include different colors of LEDs, or include more than one LED of the same color. Additionally, the pixel arrangements 24 may include four or more apertures for including a larger variety of LED colors within each pixel arrangement 24.

FIG. 8 illustrates a side view of the pixel arrangement 24 in the removable panel 20 of FIG. 7 showing the apertures 30 and the recessed area 60, and also showing a circuit board 62 bearing three LEDs 64 prior to the circuit board 62 being coupled to the removable panel 20. As stated earlier, using three LEDs 64 to form a pixel is one possible embodiment of a pixel wherein the LEDs 64 may comprise a red LED, a green LED and a blue LED.

FIG. 9 shows the circuit board 62 and removable panel 20 of FIG. 8 assembled together.

Finally, FIG. 10 shows the assembled circuit board 62 and removable panel 20 of FIG. 9 with a sealant 66 disposed in at least a portion of the recessed area 60 of the removable panel 20. The sealant 66 is disposed in the recessed area 60 to form a seal around the sides of the LEDs 64 while still leaving a top portion of the LEDs 64 exposed for efficient transmission of the light generated by the LEDs 64, as well as leaving the leads of the LEDs 64 exposed to circulating air below the removable panel 20, which enhances cooling and prevents hot spots. The sealant 66 may be any suitable sealant, caulking, foam, or gasket-type material that can form a substantially watertight seal to protect a large portion of the LEDs 64 from exposure to the elements and prevent water and other contaminates from encroaching behind the removable panel 20 and affecting the base of the LEDs 64, the circuit board 62, and other components that may be attached to the circuit board 62. For example, the sealant 66 may be a silicon sealant. The depth of sealant 66 may be adjusted depending on such factors as the desired amount of LED exposed above the sealant 66, height of the LEDs 64, and spacing between the removable panel 20 and the circuit board 62.

In FIGS. 8-10 the recessed area 60 is illustrated to encompass a pixel including three LEDs 64. However, other recessed areas 60 may be used in additional embodiments. By way of example and not limitation, a recessed area 60 may be formed around each LED 64, a recessed area 60 may be formed to encompass more than one pixel arrangement 24, and a recessed area 60 may be formed to encompass an entire pixel row 22 (FIG. 3).

The removable panel 20 of the display module 12, such as described herein, may be formed from a variety of materials, including but not limited to: plastic, metal, and composite materials, such as fiberglass. Additionally, the elements of the removable panel 20, such as the pixel apertures therethrough and the incident light management structures formed in surface regions thereof, may be formed by a variety of methods. Such methods include, but are not limited to: molding, injection molding, casting, machining, stamping, and forming.

Methods of managing incident light with panels 20 of display modules 12, such as described herein, are further described with reference to FIGS. 11 and 12.

FIG. 11 shows a cross-sectional view of a portion of a panel 70 having a substantially flat surface 72 that is substantially parallel to a display surface, and FIG. 12 shows a cross-sectional view of a portion of the removable panel 20, shown in FIG. 3, having incident light management regions 40. In FIGS. 11 and 12, rays of incident light are illustrated as dashed lines and rays of reflected light are illustrated as dotted lines. Additionally, arrowheads at the end of each dotted line indicate the direction of travel for each of the rays illustrated.

As illustrated in FIG. 11, a substantially flat surface 72 of the panel 70 which is substantially parallel to a display surface may reflect a portion of incident light received thereon at a reflection angle relative the normal of the surface 72 that is substantially the same magnitude as the incident angle relative the normal of the surface 72. In view of this, the reflected portion of the light incident upon the surface 72 may be reflected directly toward a viewer and the reflected light may disrupt or diminish the viewer's perception of the display, and may diminish the perceived contrast ratio of the display. However, incident light management regions 40, according to embodiments of the present invention, may be used to reduce or substantially eliminate reflected incident light that may be perceived by a viewer.

As illustrated in FIG. 12, each incident light management region 40 of the removable panel 20 may receive incident light onto one or more first slanted surfaces 48 and 50. For example, incident light originating from a source above the panel may be received on each upward facing slanted surface 48 of each incident light management regions 40. Each of the first slanted surfaces that receive the incident light may absorb a portion of the incident light and a portion of the incident light may be reflected toward one or more second slanted surfaces. For example, a portion of the incident light received on the upward facing slanted surfaces 48 of an incident light management region 40 may be reflected toward the downward facing slanted surfaces 50 of the incident light management region 40. In view of this, the arrangement of the slanted surfaces 48 and 50 that form the surface corrugations 42 of the incident light management regions 40 of the removable panel 20 may allow incident light to be received and partially absorbed on a first slanted surface, such as an upward facing slanted surface 48, and any light that is not absorbed may be reflected onto a contiguous facing second slanted surface, such as a downward facing slanted surface 50, having a different orientation than the first slanted surface, that may absorb some or all of the reflected light from the first slanted surface. Additionally, orienting the converging and diverging slanted surfaces 48 and 50 at an acute angle relative one another may facilitate the reflection of any unabsorbed incident light on a slanted surface 48 or 50 toward another slanted surface 48 or 50, where it may be at least partially absorbed. In view of this, the incident light management regions 40 of the removable panel 20 may allow a greater percentage of incident light received by the removable panel 20 to be absorbed by the removable panel 20, and may allow less incident light that may be reflected away from the removable panel 20 to be directed toward a viewer. The reduction of reflected incident light perceived by the viewer may improve the contrast ratio, as it may cause the removable panel 20 to appear darker to the viewer, and may cause the pixel arrangements 24 (FIG. 3) to appear brighter in contrast to the apparently dark removable panel 20.

Although this invention has been described with reference to particular embodiments, the invention is not limited to these described embodiments. Rather, the invention is limited only by the appended claims, which include within their scope all equivalent devices or methods that operate according to the principles of the invention as described.

1. A display module, comprising:
a panel comprising:
a plurality of apertures formed therethrough; and
at least one incident light management region comprising corrugations; and
at least one pixel row comprising a plurality of pixel arrangements positioned and configured to display at least a portion of an adaptable image, wherein each pixel arrangement of the plurality of pixel arrangements is positioned at least partially within at least one aperture of the plurality of apertures.

2. The display module of claim 1, wherein the corrugations of the at least one light management region are defined as a plurality of converging and diverging slanted surfaces forming a plurality of ridges and valleys, each slanted surface of the plurality of converging and diverging slanted surfaces contiguous with at least another slanted surface of the plurality of converging and diverging slanted surfaces.

3. The display module of claim 2, wherein each of the plurality of converging and diverging slanted surfaces is oriented non-parallel to a display surface.

4. The display module of claim 3, wherein each of the plurality of ridges and valleys are defined by an acute angle.

5. The display module of claim 2, wherein the plurality of converging and diverging slanted surfaces form a plurality of elongated generally pyramidal shaped structures.

6. The display module of claim 5, wherein each of the plurality of elongated generally pyramidal shaped structures includes an elongated ridge oriented substantially parallel with the at least one pixel row.

7. The display module of claim 1, wherein the at least one light management region is a dark color.

8. The display module of claim 1, further comprising a plurality of substantially horizontal pixel rows and wherein the panel further comprises a plurality of substantially horizontal shading fins positioned for shading at least one of the plurality of substantially horizontal pixel rows.

9. The display module of claim 1, wherein the at least one light management region is located adjacent each pixel arrangement of the plurality of pixel arrangements.

10. The display module of claim 1, wherein each pixel arrangement of the plurality of pixel arrangements comprises at least one LED.

11. A method of managing incident light for a light emitting display, the method comprising:
receiving incident light onto at least one first slanted surface, which is slanted relative to a display surface of the light emitting display;
absorbing at least a portion of the incident light with the at least one first slanted surface;
reflecting at least a portion of the incident light toward at least one second slanted surface, which is slanted relative to a display surface of the light emitting display and at a different angle from the at least one first slanted surface; and
absorbing at least a portion of the reflected incident light with the at least one second slanted surface.

12. The method of claim 11, wherein:
receiving incident light onto at least one first slanted surface comprises receiving incident light onto a plurality of first slanted surfaces;
absorbing at least a portion of the incident light with the at least one first slanted surface comprises absorbing at least a portion of the incident light with each of the plurality of first slanted surfaces;
reflecting at least a portion of the incident light toward at least one second slanted surface comprises reflecting at least a portion of the incident light toward a plurality of second slanted surfaces; and
absorbing at least a portion of the reflected incident light with the at least one second slanted surface comprises absorbing at least a portion of the reflected incident light with each of the plurality of second slanted surfaces.

13. The method of claim 12, further comprising orienting each first slanted surface at an acute angle relative each second slanted surface.

14. A method of making a display module, the method comprising:
forming a panel;
forming a plurality of pixel apertures through the panel; and
forming corrugations in at least one surface region of the panel to form at least one incident light management structure.

15. The method of claim 14, wherein forming corrugations in at least one surface region of the panel to form at least one incident light management structure comprises forming a plurality of contiguous alternating slanted surfaces to form a plurality of substantially parallel ridges and valleys in at least one surface region of the panel to form at least one incident light management structure.

16. The method of claim 15, further comprising orienting each of the plurality of contiguous alternating slanted surfaces non-parallel to a display surface.

17. The method of claim 16, further comprising orienting each of the plurality of contiguous alternating slanted surfaces at an acute angle relative to another contiguous slanted surface of the plurality of contiguous alternating slanted surfaces.

18. The method of claim 15, further comprising forming at least one pixel row oriented parallel to the plurality of substantially parallel ridges and valleys in at least one surface region of the panel by positioning light emitters within at least some of the plurality of pixel apertures.

19. The method of claim 14, wherein forming corrugations in at least one surface region of the panel to form at least one incident light management structure comprises forming a plurality of contiguous alternating slanted surfaces to form a plurality of generally pyramidal structures on at least one surface region of the panel to form at least one incident light management structure.
